(19) United States
(12) Patent Application Publication
(10) Pub. No.: US 2010/0202492 A1
(43) Pub. Date: Aug. 12, 2010

(54) POURING AND TEMPERATURE DETERMINING DEVICE

(76) Inventors: Robert LARIMER, New York, NY (US); Edward Kilduff, New York, NY (US); Chun Ming Cheung, North Point (HK)

Correspondence Address: Pearl Cohen Zedek Latzer, LLP, 1500 Broadway, 12th Floor, New York, NY, 10036, US

(21) Appl. No.: 12/369,841

(22) Filed: Feb. 12, 2009

(51) Int. Cl. G01K 13/00; G01K 7/22

(52) U.S. Cl. 374/185; 374/163; 374/E13.001; 374/E07.028

(57) ABSTRACT

The present invention generally relates to a pouring and temperature determining device for a wine bottle. Specifically, the present invention relates to a spout for a wine bottle which may be sealed and which provides a display of the wine temperature. In particular, the temperature of the bottle contents are displayed and stored so that the last recorded temperature may be redisplayed. By knowing the temperature of the contents of the bottle, someone desirous of consuming the wine will know if the correct temperature has been reached prior to pouring.

### BACKGROUND OF THE INVENTION

1. Field of the Invention

The present invention generally relates to a pouring and temperature determining device for a wine bottle. Specifically, the present invention relates to a spout for a wine bottle which may be sealed and which provides a display of the wine temperature. In particular, the temperature of the bottle contents are displayed and stored so that the last recorded temperature may be redisplayed. By knowing the temperature of the contents of the bottle, someone desirous of consuming the wine will know if the correct temperature has been reached prior to pouring. For instance, fine red wines are known to have improved taste and bouquet when consumed at temperatures of 60° F. to 65° F., and white wines are better appreciated at temperatures of 50° F. to 55° F. Many types of wine thermometers are made for this purpose, but their use requires a separate cumbersome and time consuming step for measuring the wine's temperature. The present invention simplifies the process of taking the temperature of wine, normally requiring the additional step of using a wine thermometer after the wine has been transferred from the bottle. The present invention eliminates this step because the thermometer is part of the pouring device itself. By knowing the temperature of the contents of the bottle, someone desirous of consuming the wine will know if the correct temperature has been reached prior to pouring.

2. Description of the Related Art

There is therefore a great need in the art for knowing the temperature of a bottle's contents prior to pouring the contents. Accordingly, there is now provided with this invention an improved pouring and temperature determining device for effectively overcoming the aforementioned difficulties and longstanding problems inherent in premier wine tasting. These problems have been solved in a simple, convenient, and highly effective way by which to pour and measure the temperature of the wine in the bottle before it is poured.

### SUMMARY OF THE INVENTION

According to one aspect of the invention, a temperature sensing device is disclosed which comprises a tubular base. The tubular base has a spout at one end of the base for providing liquid flow therethrough and a tubular sleeve at an opposite end of the base. The sleeve has concentric seals therearound so that when the sleeve is positioned in a neck of a bottle, an air-tight seal is provided therewith. The device also has a temperature probe sealed within the sleeve and extending therefrom for sensing temperature at one end and a first set of electrical contacts is positioned at an opposite end. The device further includes a head adapted for mating with the base. The head has a sealing plug for preventing liquid flow through the spout and a second set of electrical contacts for mating with the first set. A processor is connected to the second set of electrical contact and a display is connected to the processor for displaying the temperature sensed by the probe.

As will be appreciated by those persons skilled in the art, a major advantage provided by the present invention is that the temperature of a bottle's contents may be displayed and known prior to pouring. It is therefore an object of the present invention to have an attractive pouring device that may be sealed after the cork of a wine bottle has been extracted. Additional objects of the present invention will become apparent from the following description.

The method and apparatus of the present invention will be better understood by reference to the following detailed discussion of specific embodiments and the attached figures which illustrate and exemplify such embodiments.

### DESCRIPTION OF THE DRAWINGS

A specific embodiment of the present invention will be described with reference to the following drawings, wherein:

FIG. 1 is a side view cross-section of an embodiment of the invention.

FIG. 2 is an exploded orthogonal view of an embodiment of the invention.

FIG. 3 is an assembled orthogonal view of the embodiment of FIG. 2.

FIG. 4 is a side view cross-section of the base of the embodiment of FIG. 2.

FIG. 5 is a side view cross-section of the head portion of the embodiment of FIG. 2.

FIG. 6 is a side view cross-section of an embodiment of the invention inserted into the neck of a bottle.

FIG. 7 is a cross-section orthogonal view of FIG. 6.

FIG. 8 is a block diagram of an embodiment of the invention.

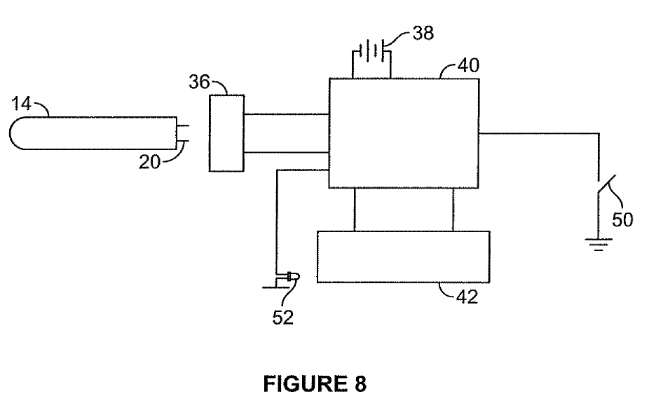

FIG. 9 is an electrical schematic of the display of an embodiment of the invention.

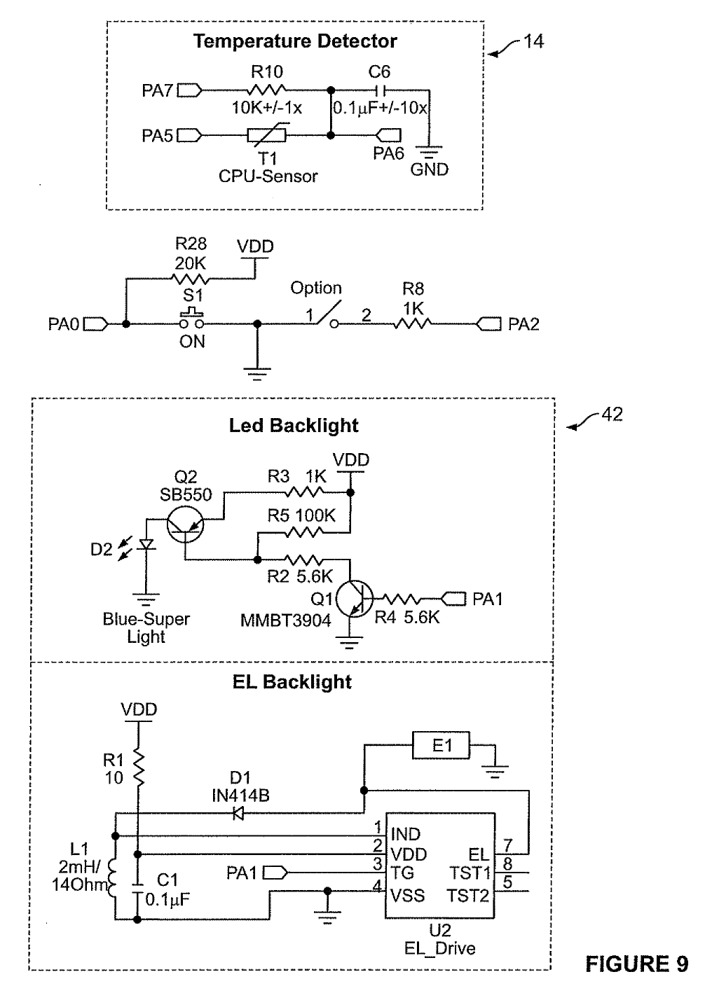

FIG. 10 is an electrical schematic of the processor of an embodiment of the invention.

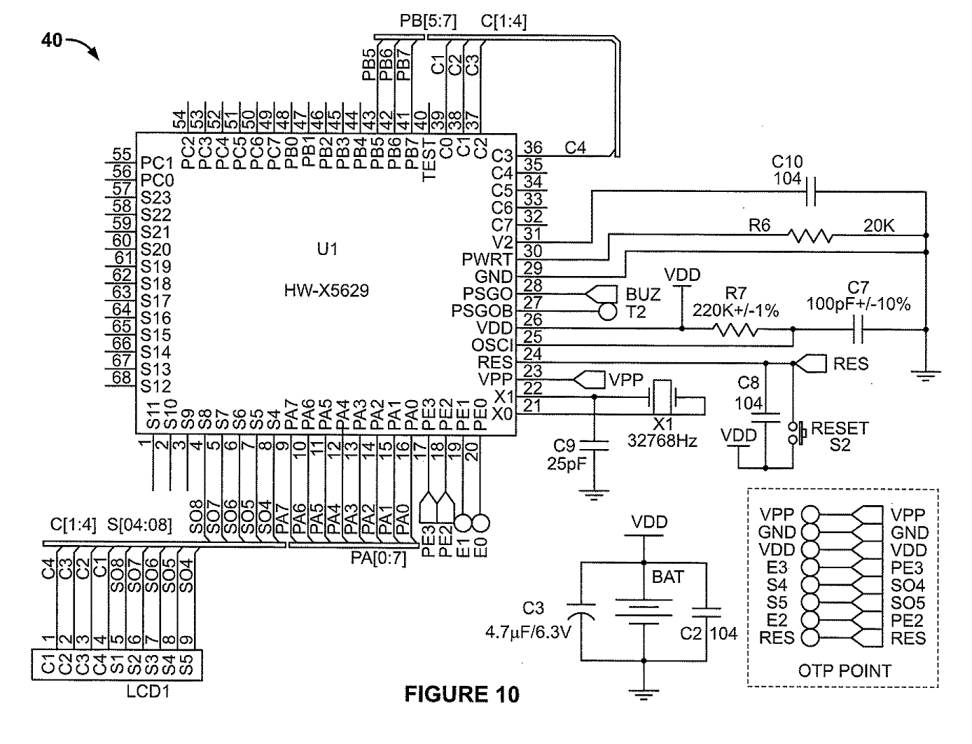

FIG. 11 is a flow diagram describing the operation of the invention.

### DESCRIPTION OF THE PREFERRED EMBODIMENT

The following preferred embodiment as exemplified by the drawings is illustrative of the invention and is not intended to limit the invention as encompassed by the claims of this application. A device for pouring, and sensing and displaying the temperature of the contents of a bottle is disclosed herein.

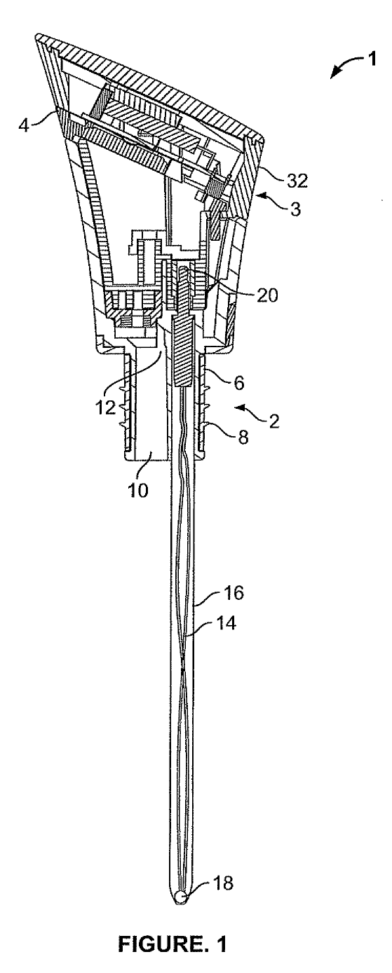

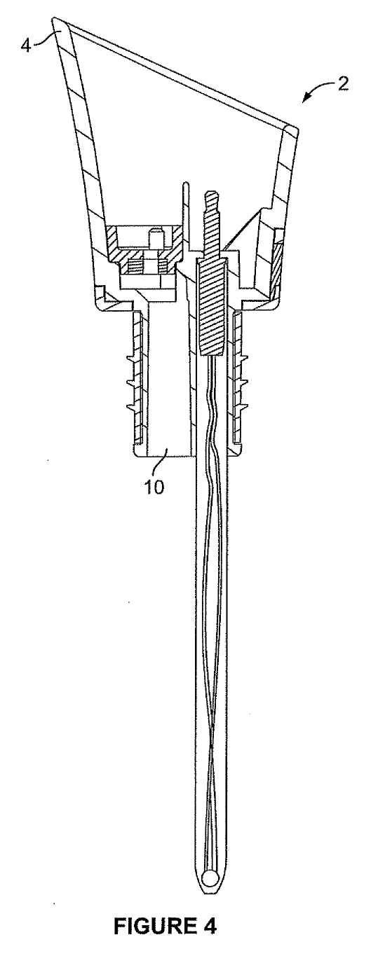

The device 1, as illustrated generally in FIGS. 1-5 comprises two main sections, a base 2 and a head 3. The base 2 and the head 3 are typically manufactured of thermoplastic material, for example, ABS plastic. Alternatively, the device could also be made of many other materials, as is well known in the arts, for example, a metal. The base has a spout 4 and a sleeve 6, distal from the spout 4. The sleeve 6 is tubular in shape and adapted to fit inside a neck of a bottle, typically, a wine bottle. To ensure a tight fit inside the neck of a wine bottle at least one seal 8 extends circumferentially around the sleeve. Preferably, the seals 8 are deformable to effectuate an air-tight or liquid-tight seal. Such seals may be typically be made of elastomeric material, for example, silicon rubber.

The sleeve has a bore 10 extending therethrough. A through-hole 12 connects the bore 10 to the spout. In this way, when the base has been placed into the neck of the bottle, the contents may be poured from the bottle through the bore, through the hole 12, and out the spout.

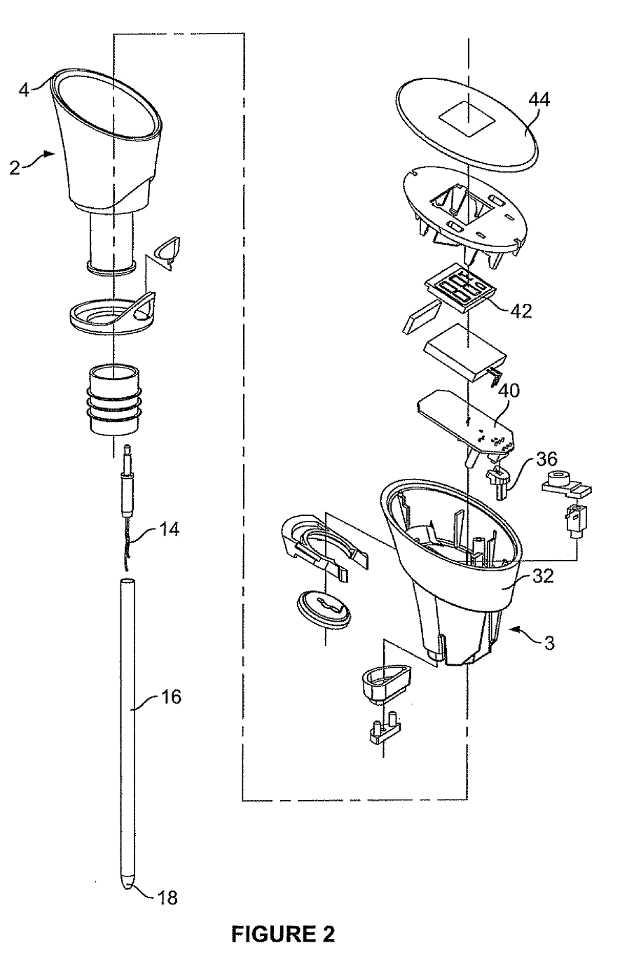

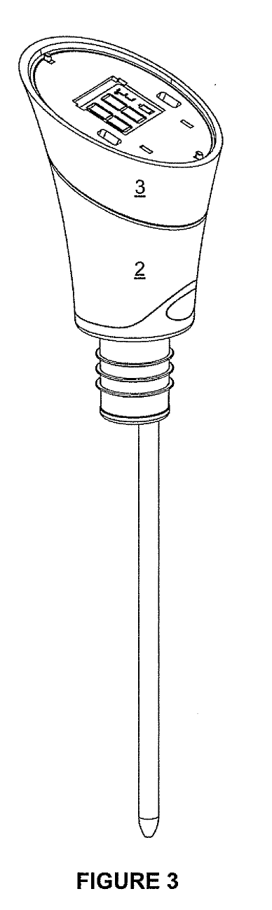

The sleeve also contains a temperature probe 14 which extends therefrom. The temperature probe 14 is sealed within the base so that when the bottle contents are poured, the contents do not flow along the probe but rather, exit only through the bore and out the spout. As shown more particularly in FIGS. 2 and 3, the temperature probe has a shaft 16 which extends from the base into the bottle. In this way, an end of the probe 18 may extend into the contents of the bottle. The probe end 18 senses the temperature of the contents into which it is immersed. The probe end is preferably a glass sealed bead which provides heat resistance and high stability. Typically, the temperature sensor is a negative temperature coefficient thermistor, for example, a silver palladium electrode type. One example of such a thermistor could be, for example, a PSB-33 thermistor as manufactured by Shibaura. At the other end of the thermistor from the probe end are electrical contacts 20. The electrical contacts 20 extend from the base in the direction opposite from the bottle.

The head 3 is adapted to securely mate within the base. To ensure a tight and aesthetic fit, the side 32 of the head is tapered in the same manner as the spout. Extending from the head is a plug 34. The plug 34 precisely mates with the through hole to effectively seal the bottle when the head is placed in the base. The plug has seals similar to the seals described on the base.

The head also has electrical contacts 36 which mate with the electrical contacts of the probe. Thus, when the head is secured into the base, the temperature probe is electrically connected with the head.

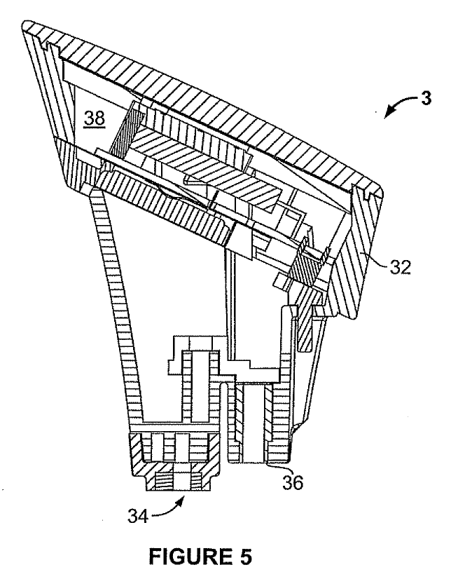

As depicted more particularly in FIGS. 2 and 5, the head further includes a power source 38, for example a battery. Such a battery can be either in the form of a replaceable battery or a rechargeable battery. If a rechargeable battery is used, the head may also be formed to mate with a recharging unit.

Within the head and connected to the power source 38 is a central processor 40, preferably, part of a pcb board. The processor 40 has a memory for recording the temperature sensed by the temperature probe. The processor is connected to a display 42 for displaying this temperature. If the head is removed from the base, the head may display the last recorded temperature.

The display is typically a liquid crystal display 42. The LCD 42 is backlit by a light emitting diode backlight 52. To protect the display, it is preferable to cover it with a plastic shield 44. As is well understood in the art, the shield 44 should be of sufficient optical quality to be able to clearly view the display and of sufficient strength to protect it from an occasional minor impact.

In order to conserve battery life, a vibration sensor 50 is connected to the processor. If the vibration sensor does not sense vibration for a predetermined period of time, for example, after 5 seconds have elapsed, the display is no longer supplied with power and thus no longer displays the recorded temperature.

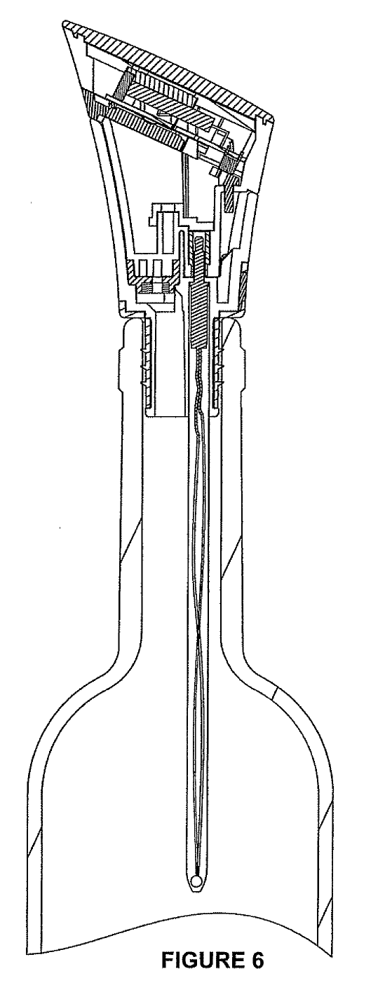

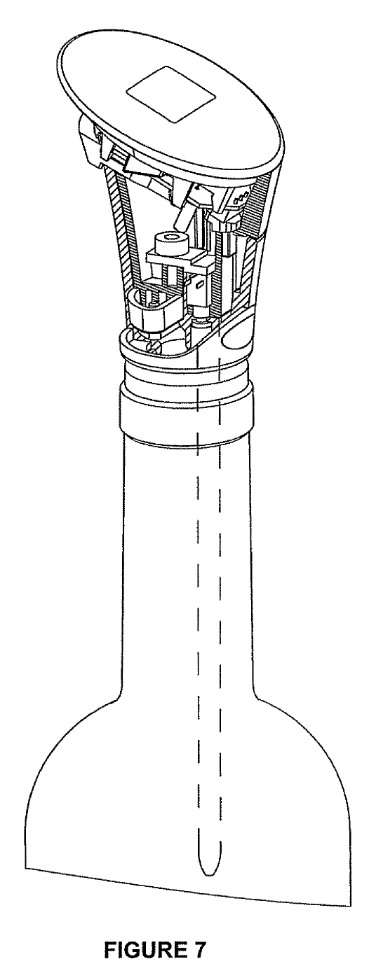

As illustrated in FIGS. 6 and 7, the device of the present invention is designed to be inserted and sealed into the neck of a wine bottle after the cork has been extracted. By placing the invention into the neck of a bottle so that the temperature sensor is immersed into the wine, the temperature may be sensed and displayed. When the temperature that is suitable for drinking has been reached, the head portion may be removed and unsealed from the base. The wine may then be poured directly from spout of the base portion which is still sealed into the neck of the bottle.

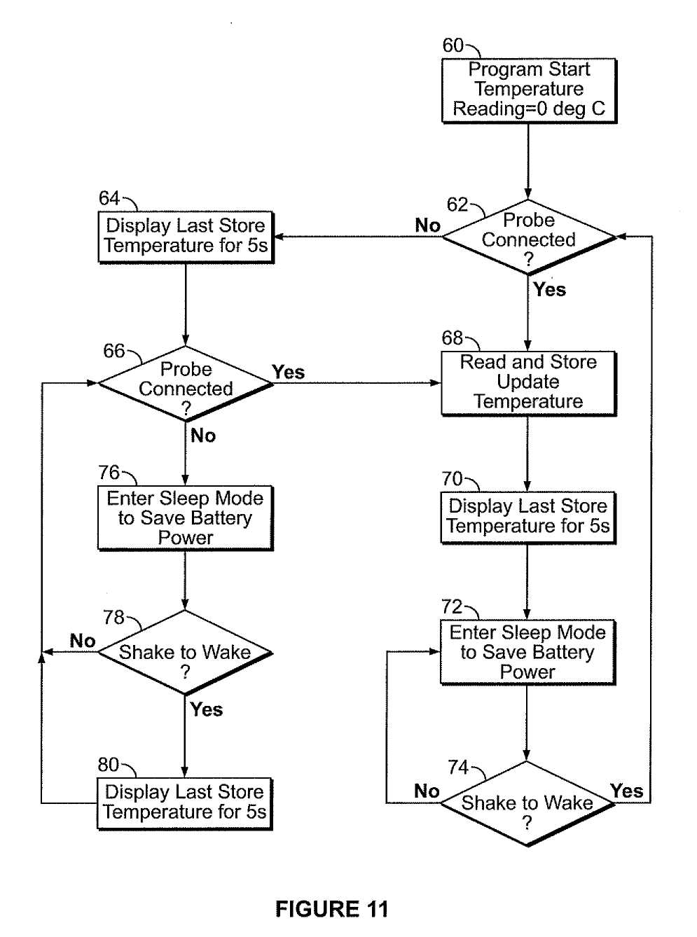

The control operation of the device of the present invention is described more particularly in FIG. 11. As illustrated therein, the processor follows the program of the flow diagram, beginning with starting to read a temperature as shown in box 60. As shown in box 62, if the probe is not connected, the last stored temperature is displayed, as shown in box 64. If the probe is connected as shown both in box 62 and box 66, then the current temperature is read and stored, as shown in box 68. As shown in box 70, the last stored temperature is displayed for a predetermined time, for example, 5 seconds. After the predetermined time interval has been reached, as shown in box 72, a sleep mode is enabled to preserve battery power. The device remains in the sleep mode until the vibration sensor is enabled, as shown in box 74 which re-enables the display.

On the other hand, if the probe is not connected as shown in box 66, then the device also enters the sleep mode to preserve battery power, as shown in box 76. The device remains in the sleep mode until the vibration sensor is enabled, as shown in box 78 which re-enables the display. The last stored temperature is then displayed for a predetermined time period, as shown inbox 80.

Although the particular embodiments shown and described above will prove to be useful in many applications to pouring and sensing the temperature of liquids in general and of pouring and sensing the temperature of wine, in particular to which the present invention pertains, further modifications of the present invention will occur to persons skilled in the oenophilic arts. All such modifications are deemed to be within the scope and spirit of the present invention as defined by the appended claims.

What is claimed is:

1. A temperature sensing device, comprising:
a. a tubular base, having:
i. a spout at one end of said base for providing liquid flow therethrough;
ii. a tubular sleeve at an opposite end of said base, wherein said sleeve has concentric seals therearound so that when said sleeve is positioned in a neck of a bottle, an air-tight seal is provided therewith;
iii. a temperature probe sealed within said sleeve and extending therefrom for sensing temperature at one end and having a first set of electrical contacts at an opposite end; and
b. a head adapted for mating with said base, wherein said head has:
i. a sealing plug for preventing liquid flow through said spout;
ii. a second set of electrical contacts for mating with said first set;
iii. a processor connected to said second set of electrical contacts; and
iv. a display connected to said processor for displaying the temperature sensed by the probe.

2. The device of claim 1, further comprising a power source connected to said processor.

3. The device of claim 2, further comprising a vibration sensor connected to said processor for turning off said display a predetermined time period after vibration has ceased.

4. The device of claim 3, wherein said display is a liquid crystal display and the device further comprises a LED backlight for said liquid crystal display.

5. The device of claim 4, wherein said display further displays the amount of power remaining in said power source.

6. The device of claim 5, wherein said processor includes a memory for displaying the last recorded temperature.

7. The device of claim 6, wherein the probe is a thermistor.
